(19) United States
(12) Patent Application Publication
(10) Pub. No.: US 2011/0099061 A1
(43) Pub. Date: Apr. 28, 2011

(54) PRODUCT DISPLAY AND PROCESS FOR SUGGESTING RELATED PRODUCTS

(75) Inventors: JASON GIFFIN, Gardena, CA (US); VICTOR SHU, Tustin, CA (US); HANOZ GANDHI, Marina Del Rey, CA (US); JAMSHED H. DUBASH, Shrewsbury, MA (US); FELIPE MARCELINI, New Bedford, MA (US); JAHANGIR D. NAKRA, Bradford, MA (US)

(73) Assignee: Belkin International, Inc., Compton, CA (US)

(21) Appl. No.: 12/564,831

(22) Filed: Sep. 22, 2009

Related U.S. Application Data
(60) Provisional application No. 61/099,132, filed on Sep. 22, 2008.

(51) Int. Cl. G06Q 30/00

(52) U.S. Cl. 705/14.49; 235/375

(57) ABSTRACT

A product display unit may include a display device and a sensor to identify a product selected for purchase by a customer. Information relating to at least one related product suggested for use with the selected product may be presented on the display device. Other embodiments are disclosed herein.

### CROSS-REFERENCE TO RELATED APPLICATIONS

This application claims the benefit of U.S. Provisional Application No. 61/099,132, filed Sep. 22, 2008 and entitled Product Display and Process for Suggesting Related Products, which is incorporated herein by reference.

### FIELD OF THE INVENTION

This disclosure relates to a product display apparatus and method for suggesting accessory products.

### DESCRIPTION OF THE RELATED ART

Customers who purchase audio-visual equipment such as HDTVs, DVD players, and audio receivers require the appropriate cables. Similarly, purchasers of home computing products such as computers, printers, and scanners may also require appropriate cables and other accessory products. Customers may have to rely on their own knowledge, or the recommendations of sales personnel who may not have adequate expertise or training Many customers end up purchasing the lowest quality cables or the wrong type of cables and other accessories for their equipment.

### DESCRIPTION OF THE DRAWINGS

The invention will be better understood from a reading of the following detailed description of examples of embodiments, taken in conjunction with the accompanying figures in the drawings in which:

FIG. 1 is a perspective view of an exemplary product display.

FIG. 2 is a exemplary display screen presentation.

FIG. 3 is a block diagram of a product display apparatus.

FIG. 4 is a flow chart of a process for suggesting related products.

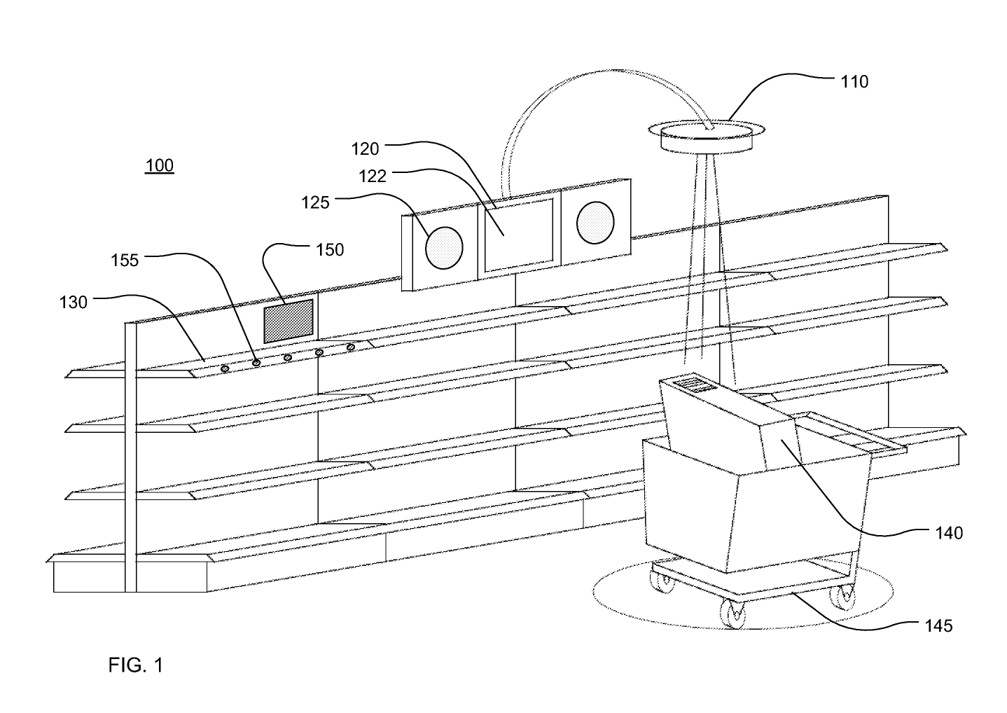

Throughout this description, elements appearing in the block diagrams of FIG. 1-FIG. 5 are assigned three-digit reference designators, where the most significant digit is the figure number and the two least significant digits are specific to the element. An element that is not described in conjunction with a block diagram may be presumed to have the same characteristics and function as a previously-described element having a reference designator with the same two least significant digits.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

Throughout this description, the embodiments and examples shown should be considered as exemplary, rather than limitations on the apparatus and methods disclosed or claimed.

In a number of embodiments, a product display unit can include: (a) a means to identify a selected product; and (b) a display device to present information to suggest at least one related product.

In other embodiments, a method of suggesting a related product can include: (a) identifying a selected product; and (b) presenting information describing at least one product related to the selected product.

Referring now to FIG. 1, an exemplary product display 100 may include a sensor 110 to identify at least one product 140 selected by a customer, a display device 120 to present information on other products related to the selected product 140, and shelves 130 or other means to hold the related products. While the following description will be describe a situation where the customer has selected a single product, the described apparatus and method are applicable to situations where the customer has selected multiple products. Customers may commonly select multiple products. For example, a customer may select multiple items of audio-visual equipment, and the product display 100 may present information on cables and other accessories recommended to interconnect the audio-visual equipment to form an integrated home entertainment system.

In FIG. 1, the selected product 140 is shown within a shopping cart 145. However, the shopping cart 145 is not a necessary element. The selected product 140 may be hand-carried by a customer or sales person, or may be conveyed in a shopping basket, shopping cart, dolly, hand truck, or other means appropriate to the size of the selected product. In some circumstances, the selected product 140 may not be physically present.

A selected product 140 may be an item of consumer electronic equipment. For example, the selected product 140 may be an item of audio-visual equipment such as a television, a flat panel monitor, a Digital Video Disc (DVD) player or recorder, a digital video recorder, a video cassette recorder, a video camera, a digital camera, an audio amplifier or receiver, a cassette player, Compact Disc (CD) player or other audio media player, speakers, or other audio-visual equipment. The selected product 140 may be an item of computing equipment such as a desk-top computer, a laptop computer, a computer monitor, a printer, a scanner, a mouse or other pointing device, a keyboard, a game controller, or other item of computing equipment. The selected product 140 may be some other type of product entirely.

Depending on the nature of the selected product, suggested related products may include: cables required to connect the selected product; recordable medium, such as, for example, blank CDs or DVDs for use in the selected product; software; prerecorded audio-visual media for use in the selected product; consumables for use in the selected product; peripheral products; or other accessory products. In some examples, the product display 100 may be used to recommend and present information relating to tangible related products such as cables and recordable media. In the same or other examples, the product display 100 may be used to recommend and present information relating to intangible related products such as extended warrantees, maintenance agreements, and internet service. In further examples, the product display 100 may be used to recommend and present information relating to related services such as training and installation support. The product display 100 may be used to recommend and present information relating to any combination of tangible, intangible, and service related products.

The product display 100 may be used to present information of any type related to the selected product. The product display 100 may serve to educate the customer on the selected product as well as the use and installation of the selected product and the recommended related products. Information presented on the product display may include specifications, warranty information, installation information, operation instructions, and other related information.

In situations where the product display 100 identifies more than one selected product, the product display 100 may provide an indication that the plurality of selected products are or are not mutually compatible. In cases where a plurality of selected products are determined to be mutually incompatible, the product display 100 may recommend one or more alternative products.

The product display 100 may not be limited to suggesting only related products that are sold or stocked at the location where the customer is purchasing the selected product 140. The product display 100 may suggest related products that are not sold at the location of the product display 100. For example, the product display 100 may suggest related products that can be ordered through the product display 100 or by other means, such as the Internet, using information provided by the product display 100.

The application of the product display 100 is not limited to situations where the selected product 140 is an item of audio-video equipment, an item of computing equipment, or some other consumer electronics product. The product display 100 may be used to present and suggest any type of merchandise or service that might be related to any product selected by a customer. As an example, recommendations for steak sauce, cooking classes, or barbecue grills could be suggested to a customer purchasing meat in a grocery store.

The sensor 110 may be a radio frequency identification (RFID) sensor to identify the selected product by interrogating an RFID tag attached to the selected product 140. In this context, the phrase “attached to” is intended to encompass tags permanently or temporarily attached to, or embedded within, the select product itself or the packaging materials for the selected product. The RFID sensor 110 may interrogate the RFID tag to determine the type of the selected product. The type of selected product may be determined by the name of the manufacturer and model number or UPC code or by some other descriptive data.

The sensor 110 may be an optical sensor to identify the selected product by scanning a bar-code or some other optical indicia attached to the exterior of the selected product or the packaging materials for the selected product. The optical indicia may be printed on the packaging materials or may be permanently or temporarily affixed to the selected product or packaging materials. The type of selected product may be determined by the name of the manufacturer and model number or UPC code or by some other descriptive data. The sensor 110 is not limited to an RFID sensor or an optical sensor and may be any type of sensor that can identify the selected product.

The sensor 110 may be disposed on an arm extending from the product display 100, as shown in FIG. 1. The sensor 110 may be disposed on or within the product display 100, or on or within the structure of a building. For example, sensor 110 may be disposed under the floor or on the ceiling in heavily-trafficked areas of a store. The sensor 110 may be hand-held and operated by a customer, a sales person, or another person. A hand-held sensor may be connected to the product display by means of a cable or a wireless communication link. The sensor 100 may be comprised of multiple sensor units that may be disposed to interrogate the selected product from multiple directions. The sensor 100 may be comprised of multiple sensor units that are distributed between multiple locations within a store.

The display device 120 may be a flat-panel display or other display device. The display device 120 may be disposed on the product display at any location where display device 120 may be conveniently viewed by a customer. The display device may be disposed at approximately eye-level as shown in FIG. 1.

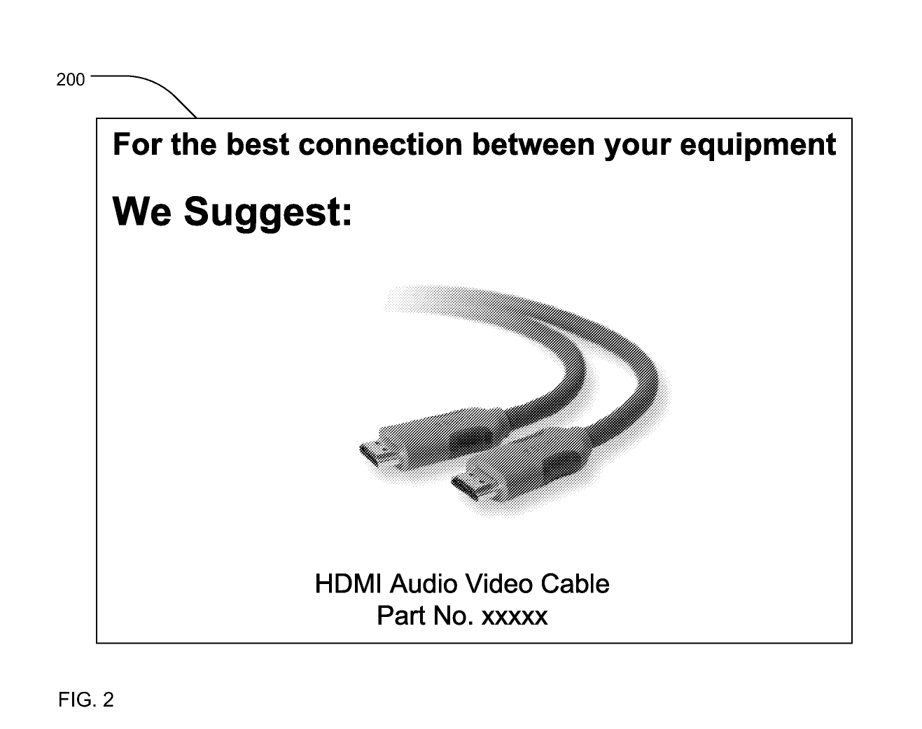

The display device 120 may be used to present information on related products suggested or recommended for use with the selected product sensed by the sensor 110. Referring to FIG. 2, an exemplary display screen 200 may recommend a specific High-Definition Multimedia Interface (HDMI) cable to a customer who has selected a high definition television or a high definition video recorder. The information presented on the display device may include the name, description, and/or model number of one or more related products suggested for use with the selected product. The information presented on the display device may also include pictures of recommended related products, information on the location of recommended related products either on the product display 100 or within the retail store, contact information for purveyors of related services or intangible related products, and any other information that may be helpful to the customer purchasing the selected product. The display device 120 may also be used to present a uniform resource locator (URL) or Internet address leading to a Web page containing additional information on the installation and use of the selected product and/or the recommended related products.

The product display 100 may include a manual input device to allow a customer to interact with the product display 100. The manual input device may be, for example, a touch screen 122 integrated with display device 120, a mouse or other pointing device (not shown), or a keyboard (not shown). The manual input device and the display device 120 may be adapted to allow a customer to identify a selected product in situations where the selected product is not physically present.

The product display may include an audio system, which may include one or more speakers 125, to play prerecorded or synthesized messages describing products related to the selected product 140. The audio system may serve as a means to gain customer attention, and may serve as an aide to the visually-impaired. The audio system may serve as an augmentation or an alternative to the display device 120. The audio system may be adapted to provide the same information available on the product display. Thus the audio system may make audible recommendations of related products and may provide information relating to the selected product as previously described.

Referring back to FIG. 1, the product display 100 may include means for holding some or all of the related products that may be recommended. In the example of FIG. 1, the means for holding the related products are shown as the shelves 130. Other means may be used for holding the related products, including but not limited to pegs, hooks, hangers, racks, bins, drawers, and combinations thereof. The means for holding the related products may include means for identifying the recommended related products to the customer. Means for identifying the recommended related products may include lights 150 behind the recommended related products, lights 155 adjacent to the recommended related products or the associated holders, vibrating holders for the recommended related products, vibrating tags within the recommended related products, and other identification means.

In FIG. 1, the product display 100 is depicted as a free-standing unit. However, the product display 100 may be integrated with a check-out line or other existing structure within a store. The product display may also be distributed between multiple physical locations, and may consist of multiple sensors, multiple display devices, multiple arrangements of related products, and combinations thereof.

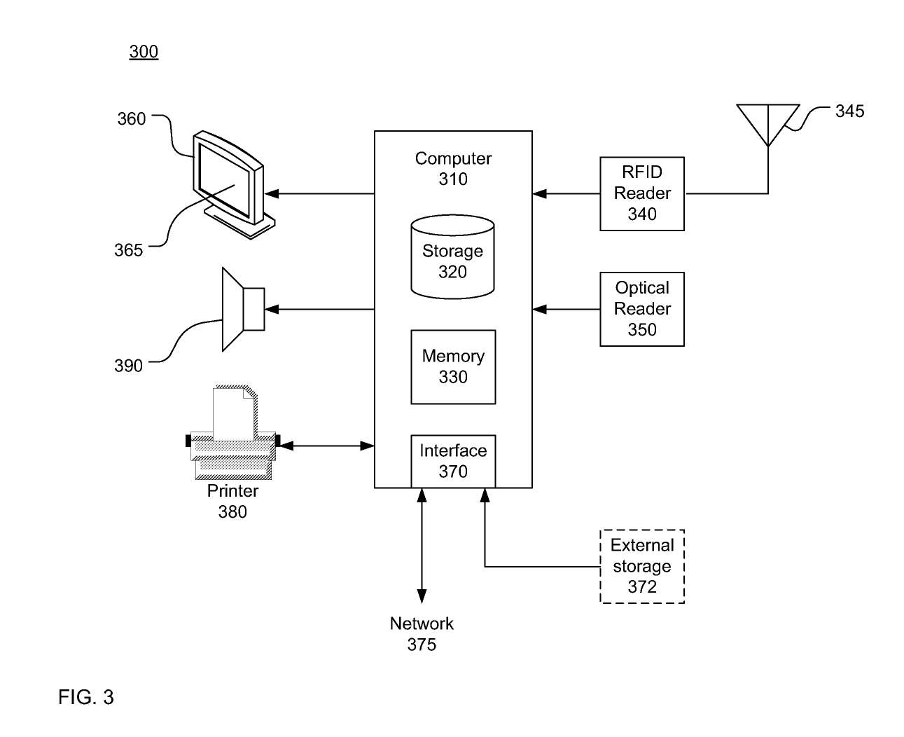

Referring now to FIG. 3, a product display apparatus 300 may include a computer 310 connected to a display unit 360 and to one or more sensor units such as an RFID reader 340 or an optical reader 350. The RFID reader 340, if present, may be self-contained, or may be connected to one or more antennas such as antenna 345. The computer 310 may optionally be connected to a printer 380, to an audio system 390, and to a network 375 by means of a network interface 370. The computer 310 may include memory 330 and storage device 320. As used herein, a storage device is a device that allows for reading and/or writing to a storage medium. Storage media include, for example, magnetic media such as hard disks, floppy disks and tape; optical media such as compact disks (CD-ROM and CD-RW) and digital versatile disks (DVD and DVD±RW); flash memory cards; and other storage media. The storage device 320 may store data, such as tables of products and related products, required in the operation of the product display. The storage device 320 may store one or more application programs in the form of instructions that, when executed, cause the computer 310 to control the operation of the product display as described herein.

The computer 310 may include software and/or hardware for providing functionality and features described herein. The computer 310 may therefore include one or more of: memories, analog circuits, digital circuits, software, firmware, and processors such as microprocessors, digital signal processors, network processors, field programmable gate arrays (FPGAs), application specific integrated circuits (ASICs), programmable logic devices (PLDs), and programmable logic arrays (PLAs). The hardware and firmware components of the computer 310 may include various specialized units, circuits, software and interfaces for providing the functionality and features described herein. The processes, functionality and features may be embodied, in whole or in part, in software which operates on the computer 310 and may be in the form of firmware, an application program, an applet (e.g., a Java applet), a browser plug-in, a Component Object Model (COM) object, a dynamic linked library (DLL), a script, one or more subroutines, or an operating system component or service. The computer 310 may run an operating system, including, for example, variations of the Linux, Unix, MS-DOS, Microsoft Windows, Palm OS, Solaris, Symbian, and Apple Mac OS X operating systems. The hardware and software and their functions may be distributed such that some components are performed by the computer 310 and others by other devices.

The computer 310 may receive data identifying a product selected by a purchaser from a sensor such as RFID reader 340 or optical reader 350. The computer 310 may receive data identifying a product selected by a purchaser from a manual input device. The computer 310 may be adapted to identify at least one recommended related product for the selected product. For example, the computer 310 may include a database defining relationships between selected products and related products. The computer 310 may also contain a database of information describing related products. Once a recommended related product has been identified, the computer 310 may generate a display screen format for presentation on the display device 360.

The display device 360 may be a flat panel display or other suitable display device. The display device 360 may include a manual input device such as a touch sensitive surface 365 to allow a customer or other person to interact with the product display 300. The product display 300 may include a separate manual input device, such as a keyboard or pointing device, not shown in FIG. 3.

The computer 310 may include one or more interfaces 370. The one or more interfaces may include a wired or wireless interface to a network 375. The network 375 may be the Internet or another network such as a private local area network or wide area network. The network 375 may be accessed by means of conventional public switched telephone network (either dial-up or DSL); by means of a cable modem, satellite modem, or other high bandwidth connection; or by means of a WiFi or other wireless connection to a wireless router. The one or more interface 370 may include a USB port or other wired or wireless interface to an external storage device 372.

The one or more interfaces 370 may be used to load or update the database of information describing related products. The database may be updated by means of a wired or wireless connection to a network. In this case, the database may be updated at periodic intervals or at irregular intervals driven by the release of new products. The computer 310 may also request a real-time update whenever a new selected product is detected. The database of information describing related products and the instructions that cause the computer to control the product display may also be updated periodically or irregularly by means of a wired or wireless interface to the external storage device 372, which may be, for example, a thumb drive, a memory stick, a flash memory, or an external CD/DVD drive.

The display apparatus 300 can also include a wake-up sensor (not shown). The wake-up sensor can alert the computer 310 that a selected product is ready to be identified. In some embodiments, the wake-up sensor can be an optical sensor, such as, for example, an infrared sensor, that can detect whether an item is located within a certain proximity of the display apparatus 300. In other embodiments, the wake-up sensor can be a sensor that can detect vibrations. As an example, the wake-up sensor can be used to determine when a selected product has been placed against a surface of the display apparatus 300. In further embodiments, the wake-up sensor can be a timer. As an example, the wake-up sensor can wake up the computer 310 after a certain time period, and then the computer 310 can receive any information about a selected product via the RFID reader 340 and/or optical reader 350. In addition, more that one type of the wake-up sensor can be included in the display apparatus 300.

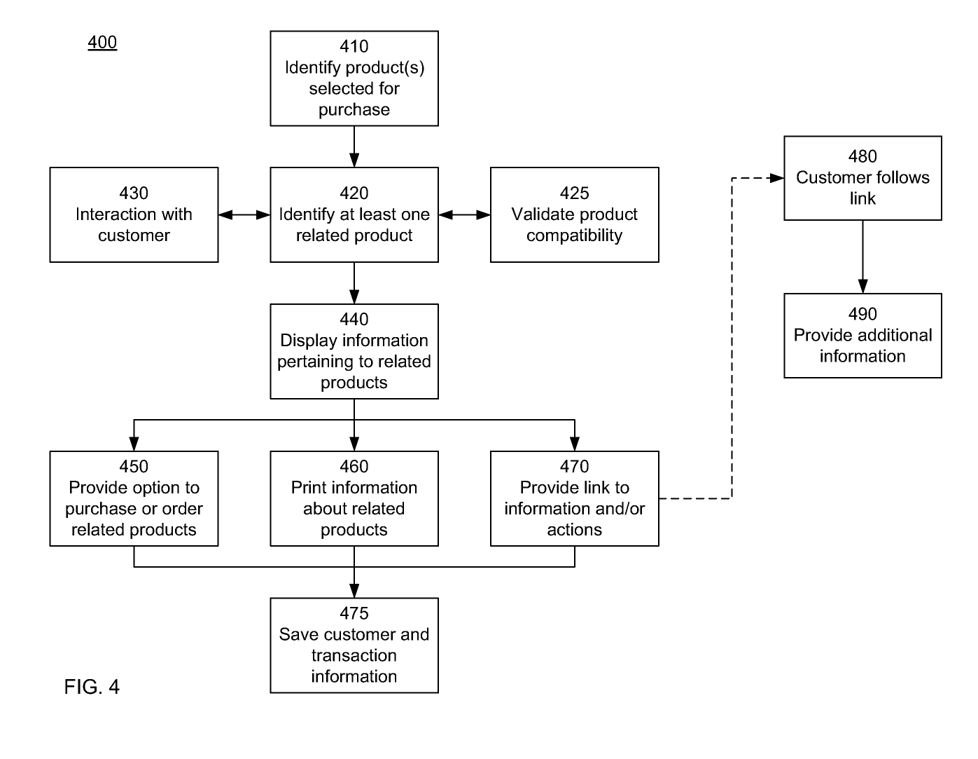

Referring now to FIG. 4, a method 400 of recommending related products begins at 410 when one or more products selected for purchase are identified. The method 400 may be compatible with the product display 100, the product display apparatus 300, and other apparatuses. The selected products may be identified by an RFID reader, an optical reader, or other sensor as previously described. In some cases, it may be necessary to identify a selected product without the selected product being physically present. For example, a customer may have already purchased the selected product, or the selected product may be physically too large to be positioned at the product display. In cases where the selected product is not physically present, the customer may be provided with a product tag that can be sensed by the product display. Alternatively, the customer may identify the selected product by manually entering identifying information. For example, the customer may designate the product from a list displayed on the product display, or may simply enter the product model number or other identifying information using a manual input device.

At 420, at least one recommended related product for the selected product or products may be identified. For example, a recommended related product may be identified by consulting a database relating products and accessories. In order to identify a recommended related product, interaction with a customer may occur at 430. For example, if the selected product is an item of audio-visual equipment, the customer may be asked to identify what other equipment (possibly already owned) will be connected to the equipment selected for purchase. The recommended accessory cables may then be identified based on the sensed identification of the select product and the customer's responses. The queries to the customer and the responses from the customer may be communicated by means of a flat panel display with a touch-sensitive screen, or by some other method.

After at least one recommended related product is identified at 420, information pertaining to the recommended related product or products may be presented on a display device at 440. The information presented on the display device may include the name, description, and/or model number of one or more related products recommended for use with the selected product. The information presented on the display device may also include pictures of recommended related products; information on the location of recommended related products, such as, for example, the location of the recommended related products on a product display or within the retail store; contact information for purveyors of related services or intangible accessory products, and any other information that may be helpful to the customer purchasing the selected product. In addition to presenting information on the recommended related product on the display device, a product display may also identify the related product by means of lights or vibrating tags as previously described.

In situations where two or more selected products are identified at 420, the mutual compatibility of the two or more selected products may be validated at 425. The customer may be provided with a message or other indication if the two or more selected products are, or are not, mutually compatible. In cases where the two or more selected products are not mutually compatible, an alternative to at least one of the selected products may be recommended.

At 450, the customer may be allowed to take an immediate action, such as selecting one or more recommended related products for immediate purchase, or ordering one or more recommended related products for delivery. For example, the customer may be able to order recommended related products that are not in-stock or not sold at the customer's present location.

In the same or other examples, information relating to the recommended related products may be printed at 460. In addition, at 470, an Internet URL or other link to additional information or actions may be displayed, printed, or otherwise provided to the customer.

At 475, information about the customer, the selected products, the recommended products, any purchases or orders made by the customer in response to recommendations, and/or other aspects of the transaction may be saved for future analysis. Information relating to the performance and status of the product display may also be saved for analysis and fault diagnosis. Information relating to transactions and/or the status of the product display may also be reported, for example over a network, in real time or periodically.

At 480, the customer may use the link provided at 470 to access the Internet or other network to receive additional information relating to the selected product and/or the recommended related products at 490. The customer may also be given the opportunity to purchase or order the recommended related product(s) at 490.

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

As used herein, “and/or” means that the listed items are alternatives, but the alternatives also include any combination of the listed items.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and processes discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

It is claimed:

1. A product display unit, comprising
a means to identify a selected product; and
a display device to present information to suggest at least one related product.

2. The product display unit of claim 1, wherein:
the means to identify the selected product is an RFID sensor to sense an RFID tag attached to the selected product.

3. The product display unit of claim 1, wherein:
the means to identify the selected product is an optical sensor to read optical indicia attached to the selected product.

4. The product display unit of claim 1, wherein:
the means to identify the selected product is a manual input device.

5. The product display unit of claim 1, further comprising:
a computer to select the at least one related product.

6. The product display unit of claim 1, further comprising:
a means for holding a plurality of the at least one related product.

7. The product display unit of claim 1, further comprising:
a printer to print information relating to the at least one related product.

8. The product display unit of claim 1, wherein:
the information presented on the display device comprises at least one of:
a part number of the at least one related product;
a name of the at least one related product;
a description of the at least one related product;
a picture of the at least one related product; or
a location of the at least one related product.

9. The product display unit of claim 8, wherein:
the information presented on the display device further comprises a URL providing access to further information pertaining to the at least one related product.

10. The product display unit of claim 9, wherein:
the further information pertaining to the at least one related product comprises at least one of:
an installation diagram;
installation instructions; or
operating instructions.

11. The product display unit of claim 1, wherein:
the selected product is an item of electronic equipment product;
the at least one related product is selected from:
a cable;
a recordable medium;
a pre-recorded medium;
a software product; or
a consumable product.

12. The product display unit of claim 1, wherein:
the at least one related product is selected from:
a tangible product;
an intangible product; or
a service.

13. A method of suggesting a related product, comprising:
identifying a selected product; and
presenting information describing at least one product related to the selected product.

14. The method of suggesting a related product of claim 13, wherein:
identifying the selected product further comprises sensing an RFID tag attached to the selected product.

15. The method of suggesting a related product of claim 13, wherein:
identifying the selected product further comprises reading optical markings attached to the selected product.

16. The method of suggesting a related product of claim 13, wherein:
identifying the selected product further comprises at least one of:
sensing a product tag;
selecting a product from a list of products presented on a display; or
manually entering identifying information.

17. The method of suggesting a related product of claim 13, further comprising:
identifying the at least one product related to the selected product.

18. The method of suggesting a related product of claim 13, further comprising:
holding a plurality of the at least one related product.

19. The method of suggesting a related product of claim 13, further comprising:
printing the information pertaining to the at least one related product.

20. The method of suggesting a related product of claim 13, wherein:
presenting the information describing the at least one related product comprises presenting at least one of:
a part number of the at least one related product;
a name of the at least one related product;
a description of the at least one related product;
a picture of the at least one related product; or
a location of the at least one related product.

21. The method of suggesting a related product of claim 20, wherein:
presenting the information describing the at least one related product further comprises presenting a URL providing access to further information pertaining to the at least one related product.

22. The method of suggesting a related product of claim 21, wherein:
the further information pertaining to the at least one related product includes at least one of:
an installation diagram;
installation instructions; or
operating instructions.

23. The method of suggesting a related product of claim 13, wherein:
the selected product is an item of electronic equipment product; and
the at least one related product is selected from:
a cable;
a recordable medium;
a pre-recorded medium;
a software product; or
a consumable product.

24. The method of suggesting a related product of claim 13, wherein:
the at least one related product is selected from:
a tangible product;
an intangible product; and
a service.

25. The method of suggesting a related product of claim 13, further comprising:
identifying at least one second selected product;
determining if the selected product and the at least one second selected product are mutually compatible; and
suggesting at least one alternative product if the selected product and the at least one second selected product are not mutually compatible.
